(19) United States
(12) Patent Application Publication
(10) Pub. No.: US 2026/0357362 A1
(43) Pub. Date: Nov. 12, 2026

(54) Biochar in steelmaking

(71) Applicant: Regents of the University of Minnesota, Minneapolis, MN (US)

(72) Inventors: Brett Spigarelli, Grand Rapids, MN (US); Matthew Mlinar, Grand Rapids, MN (US); Matthew Young, Duluth, MN (US)

(21) Appl. No.: 19/102,005

(22) PCT Filed: Aug. 9, 2023
(86) PCT No.: PCT/US2023/029831

§ 371 Date: Feb. 7, 2025

Related U.S. Application Data
(60) Provisional application No. 63/396,812, filed on Aug. 10, 2022.

(51) Int. Cl. C21C 5/52; C21C 5/54; C22B 1/245; C22B 1/248

(52) U.S. Cl. CPC C21C 5/527; C21C 5/54; C22B 1/245; C22B 1/248

(57) ABSTRACT

Agglomerates for use in an electric arc furnace, wherein the agglomerates comprise iron or steel or both in particulate form and biochar held together by a binder wherein the bulk density of the agglomerates is sufficient for the agglomerates to exist within the slag of an electric arc furnace.

This disclosure relates to agglomerates composed of biochar and iron and/or steel waste materials that are applicable to electric arc furnace (EAF) steelmaking processes as a substitute for coal feedstocks.

Electric Arc furnace (EAF) is an important process for steel production. EAF is used to recycle and melt steel scrap to produce steel. An EAF process currently requires a high amount of fossil coal. Biomass derived char referred to as biochar has been used in an EAF as an alternative substitute for fossil coal. However, there are different physical properties between the biochar currently used and coal that lead to significant differences in process behavior in EAF-steel production. Specifically, the biochar whether in pellet or briquette size tends to float atop the slag being produced in the EAF process and not within the slag of the EAF process. Situated above the slag, the benefits of the biochar are not being realized, including insulating the molten metal bath, protecting the refractory and electrodes, and preventing impurities from entering the molten metal.

### SUMMARY

This disclosure describes a method of steel production in an electric arc furnace containing a slag portion above a molten metal portion by supplying an agglomerate or agglomerates comprising iron or steel waste or both in particulate form within a biochar matrix held together by a binder wherein the bulk density of the agglomerate or agglomerates is sufficient for the agglomerate or agglomerates to be within the slag portion.

This disclosure also describes a method wherein the bulk density of the agglomerates is at least about 20 lbs./ft³.

This disclosure also describes a method wherein the agglomerate or agglomerates have a carbon content of approximately 25-90% by wt.

This disclosure also describes a method wherein a volatile matter content of the agglomerate or agglomerates is approximately 3-40% wt.

This disclosure also describes a method wherein a moisture content of the agglomerate or agglomerates is less than approximately 10% wt.

This disclosure also describes a method wherein an ash content of the biochar is less than approximately 10% wt.

This disclosure also describes a method wherein an ash content of the agglomerate or agglomerates is less than approximately 90% wt.

This disclosure also describes a method wherein the carbon content of the ash of the agglomerate is 1-70% wt.

This disclosure also describes a method wherein the iron oxide content of the ash of the agglomerate is 1-80% wt.

This disclosure also describes a method wherein the agglomerate is between approximately 3/32 inches (2.38 millimeters) and three inches (76.2 millimeters) in thickness.

In another embodiment this disclosure describes agglomerates for use in an electric arc furnace, wherein an agglomerate comprises iron or steel or both in particulate form within a biochar matrix held together by a binder wherein the bulk density of the agglomerates is at least about 20 lbs./ft³ (320 kg/m³).

This disclosure also describes the agglomerates being between approximately 3/32 inches and three inches in thickness.

This disclosure also describes the agglomerates having a fixed carbon content of approximately 10-90% by wt.

This disclosure also describes the agglomerates having a volatile matter content of approximately 3-40% wt.

This disclosure also describes the agglomerates having a moisture content of less than approximately 10% wt.

In another embodiment, the disclosure describes a method of producing an agglomerate or agglomerates for use in an electric arc furnace, by comminuting iron or steel, or iron or steel byproducts or iron or steel waste or any combination thereof and biochar to a selected particle size;

Mixing the comminuted the iron or steel, or iron or steel byproducts, or iron or steel waste, or any combination thereof and the biochar in selected proportions to from a mixture such that the resulting agglomerate comprises a bulk density of at least 20 lbs./ft³ and an ash content of less than approximately 90 % by wt. upon densification.

This disclosure also describes a method of producing an agglomerate wherein the agglomerate comprises the carbon content of the ash comprises approximately 25-90% by wt.

This disclosure also describes a method of producing an agglomerate wherein the iron oxide content of the ash comprises approximately comprises 1-80% wt.

This disclosure also describes a method of producing an agglomerate wherein the densification of the mixture results in the agglomerate being formed as a pellet or briquette.

### DETAILED DESCRIPTION

This disclosure describes an agglomerate containing iron/steel waste and biochar for use in an electric arc furnace (EAF) that is of sufficient density to enter and be part of the slag portion in an EAF. The aim of the agglomerate of this disclosure is to substitute for coal feedstocks and specifically to be used as a substitute for injection carbon within the slag portion or to complement injection carbon within the slag portion.

This disclosure describes an agglomerate containing iron or steel waste or both and biochar for use in an electric arc furnace (EAF) that is of sufficient density and energy content to be compliant with existing electric arc furnace charge carbon conveyance and furnace infrastructure. The aim of the agglomerate of this disclosure is also to substitute for coal feedstocks and specifically to be used as a substitute for charged carbon or to complement charged carbon in the furnace.

An EAF typically reuses existing steel, avoiding the need for raw materials and their processing. The furnace is charged with steel scrap. The EAF can also include some direct reduced iron (DRI) or pig iron for chemical balance. The EAF operates on the basis of an electrical charge between two electrodes providing the heat for the process. The power is supplied through the electrodes placed in the furnace, which produce an arc of electricity through the scrap steel (around 35 million watts), which raises the temperature to about 1600 °C, melting the scrap. Any impurities may be removed through the use of fluxes and drained off as slag through a taphole.

For purposes of this application, the phrase “electric arc furnace charge conveyance” refers to the process of transporting the raw materials, often in solid form, to an electric arc furnace (EAF) for steelmaking or other metallurgical processes. This phrase is well known in the art. However, a brief explanation is being given herein.

In the charge conveyance process, various materials such as scrap metal, iron ore, and the bio char of this disclosure are included. This charge of materials is loaded into a charging system, which can be a mechanical or automated system designed to efficiently introduce the materials into the EAF. Once the charge is in the EAF, an electric arc is created between the electrodes and the materials, generating intense heat that melts the charge. As the materials melt, chemical reactions take place, and impurities are removed, resulting in the production of molten steel or other metal alloys. This molten metal can then be further processed, refined, and eventually cast into various steel products. The purpose of the biochar is provide additional energy in to the EAF. Process thereby making the EAF. Process more energy efficient.

The basic structure of an EAF. includes:
Furnace Shell: The furnace shell is typically a large, cylindrical, and usually water-cooled vessel that contains the entire EAF setup. It is made of heavy steel plates and refractory lining to withstand the intense heat generated during the steelmaking.
Roof and Electrodes: The furnace roof is movable and covers the top of the EAF. It can be raised or lowered to allow access to the interior. Through openings in the roof, one or more graphite electrodes are inserted vertically into the furnace. These electrodes provide the electrical energy needed to create an electric arc for heating and melting the charge materials.
Electrode Regulator: An electrode regulator is a mechanism that controls the positioning of the electrodes within the furnace. It adjusts the electrode length and maintains the proper arc length during operation. This is essential for controlling the furnace's power input and temperature.
Refractory Lining: Inside the furnace shell, there is a refractory lining made of heat-resistant materials. This lining protects the furnace shell from the extremely high temperatures and chemical reactions that occur during the steelmaking process.
Hearth: The bottom part of the EAF is the hearth. It is also made of refractory materials and serves as the base for the charge materials to rest on during melting.
Cooling Systems: To prevent overheating of the furnace components, EAFs have water-cooling systems. The furnace shell, roof, electrodes, and other critical parts have water-cooling channels to dissipate excess heat.
Charging System: The charging system is responsible for introducing the raw materials, (the charge,) into the EAF. It typically includes a conveyor system or mechanical charging arms to load the scrap metal and biochar.
Off-Gas System: During the steelmaking process, gases and fumes are produced. An off-gas system is needed to capture and treat these emissions before releasing them into the atmosphere. This system helps to minimize environmental impacts and capture any usable byproducts.
Tapping System: Once the steel is fully melted and the desired chemical composition is achieved, the liquid metal is tapped out of the EAF through a tap hole located in the furnace shell. The tapping system consists of a tapping spout, ladle, and other equipment required to transport the molten metal to further processing units.

The agglomerate of this disclosure is a mixture comprising biochar, iron and steel waste, binder, and water. The agglomerate may be rod shaped, disk shaped, plate shaped, briquette shaped, or spherical. By an agglomerate is meant a particle ranging in form from a pellet to a briquette. From a size standpoint, the agglomerate may be from approximately 3/32 inches up to about three inches in thickness.

Biochar is a charcoal-like substance that is made by burning biomass through pyrolysis. There are several well-known ways of producing biochar such as thermal pyrolysis, torrefaction, or hydrothermal conversion. Nonlimiting biomass sources may include agricultural residues, waste from other industrial processes (food, paper, wood), manure, sewage sludge, landfill wastes or virgin biomass, biomass that is not the byproduct or result of an industrial or agricultural process such as algae.

Iron or steel or iron or steel byproducts or iron or steelwaste or any combination thereof and biochar are incorporated into the pellet/briquette. Nonlimiting sources for iron and steel waste include blast furnace dust, DRI (direct reduced iron) dust, DRI fines, oxide fines, iron and steel slags, EAF dust, filter fines, and sludges. The iron and steel waste may consist of cementite (iron carbide), metallic iron, silica, DRI, lime, magnesia, alumina, and iron oxides.

In one aspect of this disclosure the agglomerate is introduced in the E.A.F. as the main components of the steelmaking process. In another aspect, the agglomerate is introduced into molten steel in the E.A.F. as an additional component of the steel making process. In both embodiments, the biochar introduces additional energy for use in the steelmaking process.

In one embodiment, the agglomerate of this disclosure comprises biochar, iron and steel waste, binder, and water that has a fixed carbon by difference content of approximately 25-90%, a bulk density greater than approximately 20 lbs./ft³ (320 kg/m³), volatile matter content of approximately 3-40%, moisture content less than approximately 10%, and an agglomerate ash content less than approximately 10%. Fixed carbon by difference describes the portion of carbon that remains in the agglomerate after volatile components have been driven off or removed. The fixed carbon content is calculated by subtracting the percentage of the volatile, ash, and sulfur components from the total weight of the agglomerate.

For purposes of this disclosure, moisture content is determined according to ISO 18134-1:2022 (Solid biofuels—Determination of moisture content). For purposes of this disclosure, ash content is determined according to ISO 18122:2022(en) (Solid biofuels-Determination of Ash Content); ashing temperature of 1022 °F (550 °C). For purposes of this disclosure, volatile matter is determined according to ISO 18123:2023(en) Solid biofuels—Determination of volatile matter. For purposes of this disclosure, fixed carbon by difference is calculated according to ISO ISO 17246:2010 (en) Coal—Proximate Analysis.

The bulk density of the agglomerate is sufficient to ensure that the agglomerate is within the slag of the EAF and not above the slag. Volatile matter results from the organic components of the agglomerate. Enough moisture is added to facilitate agglomeration. Ash is minimized since ash requires energy to melt and since ash is typically an oxide it ends up being an energy sink. However, some amount of ash is not harmful though. It can help to remove impurities from the metal product

### Material Sizing

Materials undergo comminution until a suitable selected particle size is reached for the densification process and agglomerate application. Materials are pre-sized using the appropriate size reduction device such as: grinders, pulverizers, high shear paddle mixers, crushers, shredders, hammer mills, jet mills, pin mills, cage mills, and ball mills.

### Material Mixing

The sized materials are mixed with the appropriate mixing device such as a: pin mixer, ribbon mixer, paddle mixer, plow mixer, rotary drum mixer, planetary mixer, or twin shaft mixer.

### Material Densification

### Screw Extrusion/Disc Pelletizer

Prior to extrusion, binders are added to obtain the correct plasticity and cure strength of the mixture. Plasticity can be created from the cohesion forces of water and from the formation of a gel matrix within the material when using certain hydrophilic binders such as starch, lignosulfonates, etc.; plasticity can also be created with the addition of hydrophobic oils and/or polymers (lignin, waste plastics, etc.). Once the plasticity of the mixture is in the selected range the formulation is fed through a screw extruder equipped with a selected appropriate die. Frictional heat rise is considered during extrusion as plasticity is affected by temperature. Following extrusion, the material is either cut to size at the die outlet or immediately transported to a disc pelletizer set at a rotation speed that equates to a disc edge velocity in the range of approximately 100-1200 feet/min (31-366 meters/min); due to centrifugal forces, the edge speed determines the amount of energy/compaction imparted on the agglomerates. Residence time of agglomerates in the disc pelletizer can range from approximately 5 seconds to 2 minutes; residence time is dependent on material plasticity, strength, etc.

### Ring Die Pelleting

Material may be compressed through a rotating die and roller system. The appropriate compression ratio (pellet barrel length/pellet barrel diameter) is selected based on the material properties and pellet application. Die compression ratio selection is dependent on the desired density and strength of the product, material particle size, material fibrosity/brittleness, material compressibility, material lubrication character, frictional heat and melt-flow properties of materials, and desired throughput rate.

### Rotary Briquetting

Material may be compacted by a feed screw that forces material into the die space of two vertical or horizontal rollers. Material plasticity, material particle size, material fibrosity/brittleness, material compressibility, briquetter torque, briquetter roll pressure, briquetter die geometry, and briquette roll temperature all influence the final briquette properties.

### Ram Piston Briquetting

A piston forces material down a barrel with a clamped end that controls material pressure. Material plasticity, material particle size, material fibrosity/brittleness, material compressibility, piston force, barrel clamp pressure, material residence time, and barrel temperature all influence the final briquette properties.

For the agglomerate of this disclosure to be commercially viable, it must be durable. Given the nature of an EAF process and the harsh handling and delivery of material into the EAF the agglomerate has to withstand such an environment.

### Tumble Durability Testing

The agglomerates of this disclosure were tested using ASAE Standard S269.5 Pellet Durability Test. Tumble 500 grams of sample for 10 minutes at 50 rpm in a Seedburo Tumbling Can. The ASAE Standard S 269.5 requires 80-99% pellet durability which the agglomerates of this disclosure achieved. 1)

### Drop Durability Test

The purpose of this disclosure is for the agglomerate to travel within the slag of the EAF and thus the density has to be greater than approximately 20 lbs./ft^{3.}

Density Several density tests may be used, depending on the final agglomerate shape, size, and composition:

For purposes of this disclosure, measurement of the physical dimensions of the agglomerate can be done by the following tests
1) The density (g/ml) of each blend of agglomerates may be determined by measuring their mass, length, and diameter. The density can then be computed from the mass and volume (after at least 24 hours of curing).
2) Bulk density and volume of solid refractories by wax immersion method
a. See ASTM C 914-09(reapproved 1999) for a full procedure
3) Bulk density
a. The density would be measured by recording the mass of agglomerates in a known volume. The mass would then be divided by the volume to obtain a bulk density.

### Proximate and Ultimate Analysis

Proximate and ultimate analysis was conducted by Twin Ports Testing on the final products to determine the chemical properties of the agglomerates.

Analysis was as follows:
a) Moisture (0-10 wt. %)
b) Ash (5-90 wt. %)
c) Volatile matter (5-40%)
d) Fixed carbon by difference (5-90 wt. %)
e) Sulfur (0-0.1 wt. %)
f) SO2 (0-0.1 wt. %)
g) Nitrogen (0-2 wt. %)
h) high heating value (HHV) (5000-15000 BTU/pound)

Ultimate analysis will include:
a) Carbon (10-95 wt. %)
b) Hydrogen (0-3 wt. %)
c) Nitrogen (0-2 wt. %)
d) Oxygen (0-10 wt. %)

Future product test procedures might include:
a) Ash fusion analysis
b) Hydrophobicity
c) Carbon reactivity
d) Induction smelting tests
e) Slag/molten metal contact angle measurement
f) Electrical and thermal conductivity
g) Pore size distribution
h) Surface area

Water Uptake Test—This test is used comparatively to determine if hydrophobicity is more prominent in some agglomerates compared to others. Many iron and steel wastes react with water to generate heat. This test may be used to identify safe storage practices.

1. Agglomerates for use in an electric arc furnace, wherein an agglomerate comprises:
iron or steel, or iron or steel byproducts, iron or steel waste, or any combination thereof in particulate form and biochar held together by a binder wherein the bulk density of the agglomerates is at least about 20 lbs./ft³(320 kg/m³).

2. The agglomerates of claim 1 wherein the agglomerates are between approximately 3/32 inches and three inches in thickness.

3. The agglomerates of claim 1 wherein the agglomerate has a fixed carbon content difference of approximately 25-90% on a dry weight basis.

4. The agglomerates of claim 1 wherein the agglomerate has a volatile matter content as determined by ISO 18123 of approximately 3-40% on a dry weight basis.

5. The agglomerates of claim 1 wherein the moisture content of the agglomerate is less than approximately 10% wt. as determined by ISO 18134-1.

6. (canceled)

7. The agglomerates of claim 61 wherein the carbon content of the ash of the agglomerate is approximately 1-70% on a dry weight basis as determined by ISO 18122 at an ashing temperature of approximately 550 °C.

8. The agglomerates of claim 61 wherein the iron content of the ash of the agglomerate comprises approximately 1-80% on a dry weight basis.

9. A method of steel production in an electric arc furnace containing a slag portion above a molten metal portion, the method comprising:
supplying an agglomerate or agglomerates to the electric arc furnace, the agglomerate or agglomerates comprising iron or steel waste or both in particulate form and biochar held together by a binder wherein the density of the agglomerate or agglomerates is sufficient for the agglomerate or agglomerates to be within the slag portion.

10. The method of claim 9 wherein the bulk density of the agglomerates is at least about 20 lbs./ft³(320 kg/m3).

11. (canceled)

12. The method of claim 9 wherein the agglomerate or agglomerates have a fixed carbon content of approximately 25-90% by on a dry weight basis.

13. The method of claim 9 wherein a volatile matter content as determined by ISO 18123 of the agglomerate or agglomerates is approximately 3-40% on a dry weight basis.

14. The method of claim 9 wherein a moisture content of the agglomerate or agglomerates is less than approximately 10% wt. as determined by ISO 18134-1.

15. The agglomerates of claim 9 wherein an ash content as determined by ISO 18122 at an ashing temperature of approximately 550 °C of the agglomerate or agglomerates is less than approximately 90% on a dry weight basis.

16. The agglomerates of claim 15 wherein the carbon content of the ash of the agglomerate is approximately 1-70% on a dry weight basis as determined by ISO 18122 at an ashing temperature of approximately 550 °C.

17. The agglomerates of claim 15 wherein the iron content of the ash of the agglomerate comprises approximately 1-80% on a dry weight basis.

18. A method of producing an agglomerate or agglomerates for use in an electric arc furnace, the agglomerate or agglomerates, the method comprising:
comminuting iron or steel waste or both and biochar to a selected particle size;
mixing the comminuted the iron or steel waste or both and the biochar in selected proportions to form a mixture such that the resulting agglomerate comprises a bulk density of at least 20 lbs./ft³(320 kg/m³) and an ash content of the agglomerate as determined by ISO 18122 at an ashing temperature of approximately 550 °C. is less than approximately 90 % by wt. upon densification.; and
densifying the mixture to form the agglomerate.

19. (canceled)

20. The method of claim 18 wherein the agglomerate or agglomerates have a fixed carbon content of approximately 25-90% by on a dry weight basis.

21. The method of claim 18 wherein a volatile matter content as determined by ISO 18123 of the agglomerate or agglomerates is approximately 3-40% on a dry weight basis.

22. (canceled)

23. The agglomerates of claim 18 wherein the carbon content of the ash of the agglomerate is approximately 1-70% on a dry weight basis as determined by ISO 18122 at an ashing temperature of approximately 550 °C.

24. The agglomerates of claim 18 wherein the iron content of the ash of the agglomerate comprises approximately 1-80% on a dry weight basis.

25-33. (canceled)
